(19) United States
(12) Patent Application Publication
(10) Pub. No.: US 2005/0180506 A1
(43) Pub. Date: Aug. 18, 2005

(54) Unit for and method of estimating a current motion vector

(76) Inventors: Rimmert B Wittebrood, Eindhoven (NL); Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/515,736

(22) PCT Filed: May 19, 2003
(86) PCT No.: PCT/IB03/02179

(30) Foreign Application Priority Data
May 30, 2002 (EP) 02077130.9

(51) Int. Cl. H04N 7/12

(52) U.S. Cl. 375/240.16; 375/240.12

(57) ABSTRACT

The motion estimation unit (100) being arranged to estimate a current motion vector for a first group (212) of pixels, comprises: a generating unit (106) for generating a set of candidate motion vectors for the first group (212) of pixels, with the candidate motion vectors being extracted from a set of previously estimated motion vectors; a match error unit (102) for calculating match errors of respective candidate motion vectors; and a selection unit (104) for selecting the current motion vector from the candidate motion vectors. The motion estimation unit (100) is arranged to modulate a predetermined match error threshold on basis of a result of segmentation for the first image. If the match error of a first one of the candidate motion vectors is below the current predetermined match error threshold then the first one of the candidate motion vectors is selected and evaluation of further candidate motion vectors for the first group of pixels is skipped.

The invention relates to a motion estimation unit for estimating a current motion vector for a first group of pixels of an image, comprising:
generating means for generating a set of candidate motion vectors for the first group of pixels, the candidate motion vectors being extracted from a set of previously estimated motion vectors, the set of candidate motion vectors comprising a first one of the candidate motion vectors corresponding to a first one of the previously estimated motion vectors which has been selected for a second group of pixels of the image;
a match error calculation unit for calculating match errors of the respective candidate motion vectors, the calculation unit being arranged to stop calculating the match errors if the calculated match error of the first one of the candidate motion vectors is below a predetermined match error threshold; and
a selection unit for selecting the first one of the candidate motion vectors as the current motion vector if the calculated match error of the first one of the candidate motion vectors is below the predetermined match error threshold or else, for selecting the current motion vector from the set of candidate motion vectors on basis of comparing the match errors of the respective candidate motion vectors.

The invention further relates to a method of estimating a current motion vector for a group of pixels of an image, comprising:
generating a set of candidate motion vectors for the first group of pixels, the candidate motion vectors being extracted from a set of previously estimated motion vectors, the set of candidate motion vectors comprising a first one of the candidate motion vectors corresponding to a first one of the previously estimated motion vectors which has been selected for a second group of pixels of the image;
calculating match errors of the respective candidate motion vectors, the calculating match errors to be stopped if the calculated match error of the first one of the candidate motion vectors is below a predetermined match error threshold; and
selecting the first one of the candidate motion vectors as the current motion vector if the calculated match error of the first one of the candidate motion vectors is below the predetermined match error threshold or else, selecting the current motion vector from the set of candidate motion vectors on basis of comparing the match errors of the respective candidate motion vectors.

The invention further relates to an image processing apparatus comprising:
receiving means for receiving a signal representing a series of images;
such a motion estimation unit; and
a motion compensated image processing unit for determining processed images on basis of the images and the current motion vector.

An embodiment of the motion estimation unit of the kind described in the opening paragraph is known from the article “True-Motion Estimation with 3-D Recursive Search Block Matching” by G. de Haan et. al. in IEEE Transactions on circuits and systems for video technology, vol. 3, no. 5, October 1993, pages 368-379.

For many applications in video signal processing, it is necessary to know the apparent velocity field of a sequence of images, known as the optical flow. This optical flow is given as a time-varying motion vector field, i.e. one motion vector field per image-pair. Notice that an image can be part of several image-pairs.

The cited motion estimation unit relies on two basic assumptions. Firstly, objects are bigger than blocks, this means that a motion vector estimated in the neighborhood of a block will have a high correlation with the current motion vector of this block and can therefor be used as a so-called spatial prediction, i.e. spatial candidate motion vector, for this motion vector. Secondly, objects have inertia. This means that the motion of the objects does not change erratically from image to image, and the current motion vector for the current block will have high correlation with motion vectors of corresponding blocks in previous images. Motion vectors from these blocks can be used as so-called temporal predictions, i.e. temporal candidate motion vectors, for the motion vector of the current block. In order to allow updates of motion vectors, extra predictions, called random predictions, i.e. random candidate motion vectors are added which are equal to the spatial candidate motion vectors to which a small noise motion vector is added.

In the cited article this motion vector field is estimated by dividing the image into blocks. For a set of candidate motion vectors of each block match errors are calculated and used in a minimization procedure to find the most appropriate motion vector, i.e. the current motion vector, from the set of candidate motion vectors of the block. The match error is calculated by means of making a comparison of values of pixels of the block of pixels with values of pixels of a second block of pixels of a second image. In the known motion estimation unit, the match error corresponds to the SAD: sum of absolute luminance differences between pixels in a block of the first image, and the pixels of a block in a reference image, i.e. the second image, shifted by the candidate motion vector. If the reference image and the first image directly succeed each other the SAD can be calculated with:

$$SAD ( x , y , {d}_{x} , {d}_{y} , n ) := {\sum }_{i = 0}^{N} {\sum }_{j = 0}^{M} \vert Y ( x + i , y + j , n ) - Y ( x + {d}_{x} + i , y + {d}_{y} + j , n + 1 ) \vert \qquad ( 1 )$$

Here (x,y) is the position of the block, (dₓ, d_{y}) is a motion vector, n is the image number, N and Mare the width and height of the block, and Y(x,y,n) is the value of the luminance of a pixel at position (x,y) in image n.

An issue in motion estimation is computational complexity. Especially calculating the match errors of the various candidate motion vectors costs many computations. A technique called “block hopping” reduces this amount of calculations drastically. Block hopping means that a predetermined threshold for the match errors is set. If the match error, e.g. SAD, for a candidate motion vector falls below this threshold, this candidate motion vector is selected for and assigned to the current block and other candidate motion vectors of the set for the current block are ignored. That means that the calculation of match errors for other candidate motion vectors, which have not yet been calculated, is not executed.

Although “block hopping” appears to be an appropriate approach to reduce the amount of calculations, it does not perform optimal under all circumstances. One of the problems with the known motion estimation unit is that the assumption under which spatial candidate motion vector can be used, fails on object boundaries. A spatial candidate motion vector which is located in another object will have no correlation with the motion vector of the current block. Hence, at object boundaries “block hopping” is dangerous, because potentially better candidate motion vectors are skipped, i.e. not evaluated and consequently not selected.

It is an object of the invention to provide a motion estimation unit of the kind described in the opening paragraph which provides more accurate motion vector fields.

This object of the invention is achieved in that the motion estimation unit is arranged to modulate the predetermined match error threshold on basis of a result of segmentation for the image, into segments of pixels, the result of segmentation being related to a probability that a first part of the first group of pixels and a first part of the second group of pixels both correspond to a first one of the segments. Within a segment corresponding to an object in the scene being captured and represented by the image, the correlation between an appropriate motion vector of the first group of pixels and the spatial candidate motion vector of the second group of pixels is very high. The efficiency of block hopping is further increased by increasing the predetermined match error threshold within objects. In other words if the probability that the first part of the first group of pixels and the first part of the second group of pixels both correspond to the same segment, then the predetermined match error threshold for evaluating the related candidate motion vector, is increased. This is an advantage in detailed areas where the match error is usually high even for an appropriate motion vector. At object boundaries, there is much less correlation between the motion vector of the first group of pixels and the spatial candidate motion vectors. Hence “block hopping” is dangerous and the predetermined match error threshold is reduced at object boundaries. A reduced predetermined match error threshold means that the chance of “block hopping” is relatively small. Note that the term “block hopping” can also mean hopping to the next group of pixels.

Applying the result of segmentation for motion compensation is not novel. E.g. in European patent application number 01202615.9 (attorney docket PHNL010445) a hierarchical segmentation method is combined with motion estimation. However it is novel to apply the result of segmentation according to the invention: the predetermined match error threshold is modulated on basis of the result of segmentation. Hence, both the actual quality of the match, represented by the match error and the result of segmentation are applied to decide whether a particular candidate motion vector are appropriate. An advantage of the motion estimation unit according to the invention is the quality of the motion vector field. Another advantage is that the computational complexity is further reduced, without compromise for the quality of the motion vector field.

An embodiment of the motion estimation unit according to the invention is arranged to modulate the value of the predetermined match error threshold on basis of the size of the probability. A segmentation might be binary, resulting in a label per pixel indicating whether the pixel belongs or not belongs to a particular segment. However, preferably a segmentation method provides for a pixel, or group of pixels, a probability of belonging to a particular segment. Multiple probabilities for a pixel are possible too: e.g. a first probability of 20% for belonging to segment A and a second probability of 80% for belonging to segment B. This embodiment according to the invention is arranged to apply the actual probability to modulate the predetermined match error threshold. For instance, if the probability of not belonging to the same object is relatively high then the predetermined match error threshold should be relatively low, and vice versa. The advantage of this approach is a more accurate, i.e. better tuned, predetermined match error threshold and thus a better decision criterion whether “block hopping” should take place or evaluation of further motion vector candidates should be performed.

Another embodiment of the motion estimation unit according to the invention is arranged to modulate the predetermined match error threshold on basis of a ratio between a first number of pixels of the first part of the first group of pixels and a second number of pixels of the first group of pixels. Segmentation and motion estimation might be strongly correlated. That means that e.g. the segmentation is done for groups of pixels and the motion estimation is performed on the same groups of pixels. However segmentation and motion estimation might be performed independently. In that case the segmentation is e.g. performed on a pixel base and the motion estimation on a block base. As a consequence, it might be that the first part of the pixels of a group of pixels, to be used for motion estimation, are classified as belonging to segment A and another part of pixels is classified as belonging to segment B. In this latter case an “overall probability of belonging to segment A” can be calculated for the group of pixels on basis of the ratio between the number of pixels of the first part and the number of pixels of the entire group of pixels. The advantage of this approach is a more accurate, i.e. better tuned, predetermined match error threshold and thus a better decision criterion whether “block hopping” should take place or evaluation of further motion vector candidates.

In an embodiment of the motion estimation unit according to the invention the first group of pixels is a block of pixels. In principle, the group of pixels might have any shape, even irregular. A block based shape is preferred because this reduces the complexity of the design of the motion estimation unit.

In another embodiment of the motion estimation unit according to the invention, the match error calculation unit is designed to calculate the match error of the first one of the candidate motion vectors by means of subtracting luminance values of pixels of the first group of pixels from luminance values of pixels of a third group of pixels of a further image. Preferably the sum of absolute luminance differences (SAD) is calculated. The SAD is a relatively reliable measure for correlation which can be calculated relatively fast.

In another embodiment of the motion estimation unit according to the invention, the selection unit is arranged to select, from the set of candidate motion vectors, a particular motion vector as the current motion vector, if the corresponding match error is the smallest of the match errors. This is a relatively easy approach for selecting the current motion vector from the set of candidate motion vectors.

It is a further object of the invention to provide a method of the kind described in the opening paragraph which provides more accurate motion vector fields.

This object of the invention is achieved in modulating the predetermined match error threshold on basis of a result of segmentation for the image, into segments of pixels, the result of segmentation being related to a probability that a first part of the first group of pixels and a first part of the second group of pixels both correspond to a first one of the segments.

It is advantageous to apply an embodiment of the motion estimation unit according to the invention in an image processing apparatus as described in the opening paragraph. The image processing apparatus may comprise additional components, e.g. a display device for displaying the processed images or storage means for storage of the processed images. The motion compensated image processing unit might support one or more of the following types of image processing:
De-interlacing: Interlacing is the common video broadcast procedure for transmitting the odd or even numbered image lines alternately. De-interlacing attempts to restore the full vertical resolution, i.e. make odd and even lines available simultaneously for each image;
Up-conversion: From a series of original input images a larger series of output images is calculated. Output images are temporally located between two original input images;
Temporal noise reduction. This can also involve spatial processing, resulting in spatial-temporal noise reduction; and
Video compression, i.e. encoding or decoding, e.g. according to the MPEG standard or H26L standard.

Modifications of the image processing apparatus and variations thereof may correspond to modifications and variations thereof of the motion estimation unit described.

These and other aspects of the motion estimation unit, of the method and of the image processing apparatus according to the invention will become apparent from and will be elucidated with respect to the implementations and embodiments described hereinafter and with reference to the accompanying drawings, wherein:

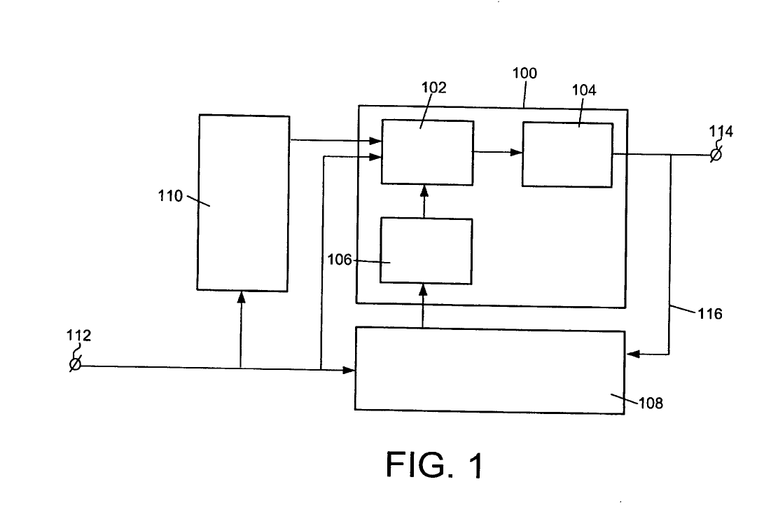

FIG. 1 schematically shows a motion estimation unit in combination with an image segmentation unit;

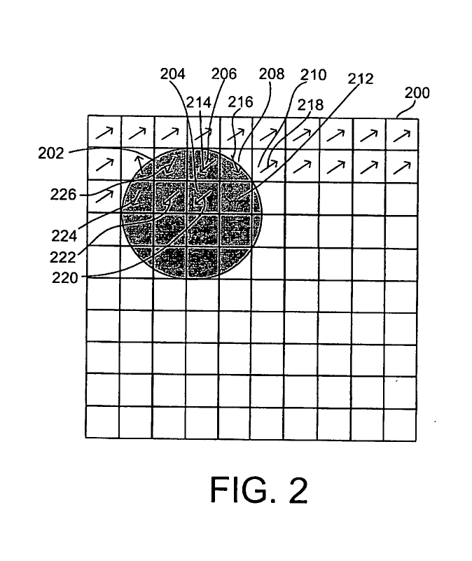

FIG. 2 schematically shows a motion vector field; and

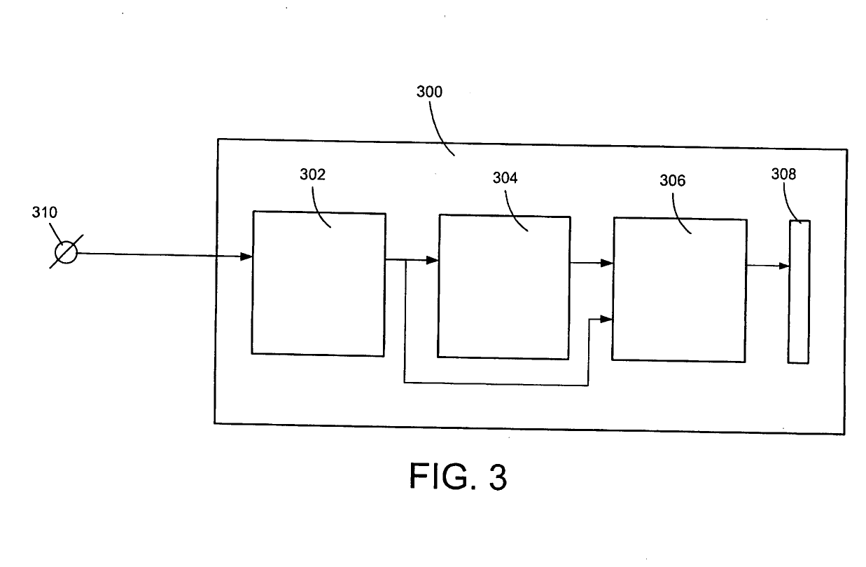

FIG. 3 schematically shows elements of an image processing apparatus, comprising a motion estimation unit, according to the invention.

Corresponding reference numerals have the same meaning in all of the Figs.

FIG. 1 schematically shows a motion estimation unit 100 in combination with an image segmentation unit 108 and a memory device 110 for storage of images. Image segmentation aims at dividing an image into segments in which a certain feature is constant or in between predetermined thresholds. For pixels or groups of pixels of the image, values are calculated representing probabilities of belonging to any of the segments. The feature can be anything from a simple gray value to complex texture measures combined with color information. The segmentation method, i.e. the method of extracting the segments, based on the chosen feature, can be anything from simple thresholding to watershed algorithms.

The motion estimation unit 100 is arranged to estimate a current motion vector for a first group 212 of pixels of an image and comprises:
a generating unit 106 for generating a set of candidate motion vectors for the first group 212 of pixels, with the candidate motion vectors being extracted from a set of previously estimated motion vectors;
a match error calculation unit 102 for calculating match errors of respective candidate motion vectors; and
a selection unit 104 for selecting the current motion vector from the candidate motion vectors.

The match error is calculated by means of making a comparison of values of pixels of the first group 212 of pixels with values of pixels of a second group of pixels of a second image. In this case the match error corresponds to the SAD: sum of absolute luminance differences between pixels in a current block of the first image, and the pixels of a second block in a reference image, i.e. the second image, shifted by the candidate motion vector. See Equation 1. In principle, match errors are calculated for all motion vector candidates of the set of candidate motion vector belonging to the current block of pixels. However, if it appears that the match error of the motion vector candidate, which has just been calculated, is below a predetermined match error threshold then the match error calculation unit 102 will not continue in calculating the match errors of the motion vectors candidates for which no match error have been calculated yet. In this case the just processed motion vector candidate is selected as the current motion vector for the current block of pixels. The motion estimation unit 100 will continue with estimating the appropriate motion vector for a subsequent block of pixels.

The motion estimation unit 100 is arranged to modulate the predetermined match error threshold on basis of a result of segmentation for the first image, into segments of pixels. First it is assumed that the segmentation unit 108 is arranged to perform segmentation on a block base. During image segmentation every block B(x,y) is assigned a label lₖ corresponding to the segment Sₖ it belongs to. This information is stored in an image segmentation mask M(x,y). In order to reduce the spatial consistency of the motion estimation unit on object boundaries, the predetermined match error threshold T is modulated according to:

$$T = \{ \begin{matrix}{T}_{high} \\ {T}_{low}\end{matrix} \begin{matrix}if M ( x , y ) = M ( {x}_{p} , {y}_{p} ) \\ if Otherwise\end{matrix} \qquad ( 2 )$$

where T_{high} is a high value in order to allow easy hopping within a segment and T_{low} is a low value in order to enforce evaluation of more motion vector candidates at object boundaries. (x,y) is the position of the current block and (xₚ,yₚ) is the position of the other block of pixels, i.e. the block of pixels for which the motion vector has been estimated and on which the motion vector candidate is based. In this case there are two different values for the predetermined match error threshold T:
T_{high} if the result of segmentation yields that the current block and the other block both belong to the same segment Sₖ; and
T_{low} if the result of segmentation yields that the current block and the other block do not belong to the same segment Sₖ.

Next it is assumed that the segmentation unit 108 is arranged to perform segmentation on a pixel base. That means that to each individual pixel a probability of belonging to segment Sₖ is assigned. The motion estimation is still on block base, i.e. motion vectors are estimated for blocks of pixels. The predetermined match error threshold T is based on the probability that pixels of the current block and pixels of the other block belong to the same segment Sₖ for k ε K. Sₖ is one out of the set of segments. The predetermined match error threshold T can be calculated with Equation 3:

$$T = C * {\sum }_{k = 0}^{K} \frac{{\sum }_{i = 0}^{N} {\sum }_{j = 0}^{M} P ( ( x + i , y + j ) ∈ {S}_{k} )}{N * M} * \frac{{\sum }_{i = 0}^{N} {\sum }_{j = 0}^{M} P ( ( {x}_{p} + i , {y}_{p} + j ) ∈ {S}_{k} )}{N * M} , \qquad ( 3 )$$

with C a constant. If the probability that pixels of the current block belong to

$$segment {S}_{k} , i . e . \frac{{\sum }_{i = 0}^{N} {\sum }_{j = 0}^{M} P ( ( x + i , y + j ) ∈ {S}_{k} )}{N * M}$$

and the probability that pixels of the other block belong to

$$segment {S}_{k} , i . e . \frac{{\sum }_{i = 0}^{N} {\sum }_{j = 0}^{M} P ( ( {x}_{p} + i , {y}_{p} + j ) ∈ {S}_{k} )}{N * M}$$

are relatively high, then the predetermined match error threshold T is relatively high.

It is assumed that the motion vector candidates are evaluated sequentially. Then it is preferred that the motion vector candidates are ordered on basis of the result of the segmentation. That means that the candidate motion vector, belonging to the block of pixels for which the probability of belonging to the same segment is the highest, compared to the probabilities related to other blocks, should be evaluated first.

It will be clear that both the value of the probability of belonging to a particular segment Sₖ per pixel is relevant and the number of pixels having a certain probability. In the case of a binary segmentation, only the number of pixels of the part of a block which is located in a segment Sₖ has to be counted, since the probability of belonging to a particular segment Sₖ is equal for these pixels: i.e. 100%.

In FIG. 1 a connection 116 is depicted from the output 114 of the motion estimation unit 100 to the segmentation unit 108. This connection 116 is optional. By means of this connection 116, motion estimation results, e.g. a motion vector field, can be applied for segmentation of an image into segments of pixels. This might be for the same image as for which the motion estimation is performed or for another image of the series of images. Besides that, it is also possible that a result of segmentation of a particular image is used for the motion estimation of an image pair which does not comprise the particular image but another image of the series of images.

The match error calculation unit 102, the selection unit 104 and the generating unit 106 of the motion estimation unit 100 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

FIG. 2 schematically shows a part of a motion vector field 200, i.e. a motion vector field under construction, of an image representing a scene with a white background in front of which a ball 202 is moving in an opposite direction related to the background. Assume that for a number of blocks 204-210 of pixels motion vectors 214-226 have been estimated and that for the current block 212 of pixels the motion vector has to be estimated. For this estimation, a set of candidate motion vectors 214-220 is created on basis of the motion vectors 214-226 previously calculated for the blocks 204-210 of pixels. In FIG. 1 can be seen that the current block 212 of pixels is located in the segment that corresponds to the ball 202. Also block 204 of pixels is located in the segment that corresponds to the ball 202. However block 210 of pixels corresponds to the background and the blocks 206 and 208 partly belong to the ball 202 and partly belong to the background. The predetermined match error thresholds for the respective candidate motion vectors 214-220 depend on the respective number of pixels of the blocks 204-210 which are labeled, by means of segmentation, as belonging to the segment representing the ball 202. Consequently the predetermined match error threshold for the match error of the candidate motion vector 220 derived from block 204 of pixels will be the highest and the predetermined match error threshold for the match error of the candidate motion vector 218 derived from block 210 of pixels will be the lowest.

FIG. 3 schematically shows elements of an image processing apparatus 300 comprising:
a receiving unit 302 for receiving a signal representing images to be displayed after some processing has been performed. The signal may be a broadcast signal received via an antenna or cable but may also be a signal from a storage device like a VCR (Video Cassette Recorder) or Digital Versatile Disk (DVD). The signal is provided at the input connector 310.
a processing unit 304 comprising a motion estimation unit 100 and segmentation unit 108 as described in connection with FIG. 1;
a motion compensated image processing unit 306; and
a display device 308 for displaying the processed images. This display device 308 is optional.
   The motion compensated image processing unit 306 requires images and motion vectors as its input. The motion compensated image processing unit 306 might support one or more of the following types of image processing: de-interlacing; up-conversion; temporal noise reduction; and video compression.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A motion estimation unit for estimating a current motion vector for a first group of pixels of an image, comprising:
generating means for generating a set of candidate motion vectors for the first group of pixels, the candidate motion vectors being extracted from a set of previously estimated motion vectors, the set of candidate motion vectors comprising a first one of the candidate motion vectors corresponding to a first one of the previously estimated motion vectors which has been selected for a second group of pixels of the image;
a match error calculation unit for calculating match errors of the respective candidate motion vectors, the calculation unit being arranged to stop calculating the match errors if the calculated match error of the first one of the candidate motion vectors is below a predetermined match error threshold; and
a selection unit for selecting the first one of the candidate motion vectors as the current motion vector if the calculated match error of the first one of the candidate motion vectors is below the predetermined match error threshold or else, for selecting the current motion vector from the set of candidate motion vectors on basis of comparing the match errors of the respective candidate motion vectors, characterized in that the motion estimation unit is arranged to modulate the predetermined match error threshold on basis of a result of segmentation for the image, into segments of pixels, the result of segmentation being related to a probability that a first part of the first group of pixels and a first part of the second group of pixels both correspond to a first one of the segments.

2. A motion estimation unit as claimed in claim 1, characterized in that the motion estimation unit is arranged to modulate the value of the predetermined match error threshold on basis of the size of the probability.

3. A motion estimation unit as claimed in claim 1, characterized in that the motion estimation unit is arranged to modulate the predetermined match error threshold on basis of a ratio between a first number of pixels of the first part of the first group of pixels and a second number of pixels of the first group of pixels.

4. A motion estimation unit as claimed in claim 1, characterized in that the first group of pixels is a block of pixels.

5. A motion estimation unit as claimed in claim 1, characterized in that the match error calculation unit is designed to calculate the match error of the first one of the candidate motion vectors by means of subtracting luminance values of pixels of the first group of pixels from luminance values of pixels of a third group of pixels of a further image.

6. A motion estimation unit as claimed in claim 1, characterized in that the selection unit is arranged to select, from the set of candidate motion vectors, a particular motion vector as the current motion vector, if the corresponding match error is the smallest of the match errors.

7. A method of estimating a current motion vector for a first group of pixels of an image, comprising:
generating a set of candidate motion vectors for the first group of pixels, the candidate motion vectors being extracted from a set of previously estimated motion vectors, the set of candidate motion vectors comprising a first one of the candidate motion vectors corresponding to a first one of the previously estimated motion vectors which has been selected for a second group of pixels of the image;
calculating match errors of the respective candidate motion vectors, the calculating match errors to be stopped if the calculated match error of the first one of the candidate motion vectors is below a predetermined match error threshold; and
selecting the first one of the candidate motion vectors as the current motion vector if the calculated match error of the first one of the candidate motion vectors is below the predetermined match error threshold or else, selecting the current motion vector from the set of candidate motion vectors on basis of comparing the match errors of the respective candidate motion vectors, characterized in modulating the predetermined match error threshold on basis of a result of segmentation for the image, into segments of pixels, the result of segmentation being related to a probability that a first part of the first group of pixels and a first part of the second group of pixels both correspond to a first one of the segments.

8. An image processing apparatus comprising:
receiving means for receiving a signal representing a series of images, comprising an image;
a motion estimation unit as claimed in claim 1 for estimating a current motion vector for a first group of pixels of the image; and
a motion compensated image processing unit for determining processed images on basis of the images and the current motion vector.

9. An image processing apparatus as claimed in claim 8, characterized in that the motion compensated image processing unit is designed to perform video compression.

10. An image processing apparatus as claimed in claim 8, characterized in that the motion compensated image processing unit is designed to reduce noise in the series of images.

11. An image processing apparatus as claimed in claim 8, characterized in that the motion compensated image processing unit is designed to de-interlace the series of images.

12. An image processing apparatus as claimed in claim 8, characterized in that the motion compensated image processing unit is designed to perform an up-conversion.
